(19) United States
(12) Patent Application Publication
(10) Pub. No.: US 2026/0212091 A1
(43) Pub. Date: Jul. 23, 2026

(54) SCALABLE PHYSICAL REACTOR REPRESENTATION

(71) Applicants: Peter SATZER, Obersdorf (AT); Manfred SATZER, Obersdorf (AT)

(72) Inventors: Peter SATZER, Obersdorf (AT); Manfred SATZER, Obersdorf (AT)

(21) Appl. No.: 19/140,803

(22) PCT Filed: Dec. 18, 2023
(86) PCT No.: PCT/EP2023/086445

§ 371 Date: Jun. 18, 2025

(30) Foreign Application Priority Data
Dec. 19, 2022 (WO) PCT/EP2022/086602

(51) Int. Cl. G06F 30/28; G06F 30/17; G06F 113/10

(52) U.S. Cl. CPC G06F 30/28; G06F 30/17; G06F 2113/10

(57) ABSTRACT

The present invention relates to a method for producing a model reactor configured to reflect specific defined fluid dynamics of a target reactor which is different in size, to model reactors produced by such method and to the use of such model reactors for scale-up or scale-down a process.

### FIELD OF THE INVENTION

The present invention relates to the field of biotechnology production plants for producing valuable products, to model reactors and their use for scale-up or scale-down of production processes.

### BACKGROUND ART

The perfect DownScale Reactor Representation (pDS) tries to solve the upscale problem in biotechnological manufacturing. In the development of biotechnological processes, small experimental reactors are initially used, usually with a volume of about 1 L or less. The process established in such an experimental small reactor is then transferred to large production reactors which usually have a volume of up to several cubic meters in a step-wise fashion. The flow-physical properties of a small reactor differ significantly from the flow-physical properties of a large production reactor, for example in the distribution of supplied nutrients or the mixing time needed. All these parameters depend on the volume and shape of the reactor used and are physically inherent to reactors of different sizes. Every transfer of a tailored process established for a specific reactor size to a different sized reactor is time and resource consuming and thus costly. The process needs to be essentially re-developed on each reactor scale.

US2021230532A1 discloses systems and methods for scalable manufacturing of therapeutic cells in bioreactors based on fluid dynamic considerations. This method tries to optimize conditions for cultivation without changing reactor geometries.

WO2020205611A1 describes a computational method of modeling a bioreactor by combining mechanistic models of kinetics of metabolic fluxes and flux balance analysis in order to predict cell culture performance in a reactor. Without a universally valid cell metabolic model that is culture and product independent, these approaches are of limited prediction power.

CN11283644A discloses an optimization method of dry anaerobic biogas stirring system based on Computational Fluid Dynamics (CFD). Described is the optimization of CFD modelling by changing different factors within the CFD model itself to obtain a more accurate representation of the CFD modelling of a dry anaerobic biogas mixing system. Further described is the use of an optimized high performance CFD modelling to simplify the calculation model and enable fast evaluation of pre-defined structures. The “optimized model” as referred to in CN11283644A relate to the optimization of the CFD modelling process itself and not to the inner geometry of the reactor.

Additionally, some work on non-stirred vessels and static mixers was presented before, using CFD as investigation tool without automated random design.

For instance, US2019/0388859 A1 describes the CFD evaluation of static mixers for continuous flow catalytic reactors. The static mixers can be configured for use with continuous flow chemical reactors, for example tubular continuous flow chemical reactors for heterogeneous catalysis reactions.

CN112100944A describes the use of CFD to visualize a multiphase system and evaluate different pre-defined reactor geometries. It refers to the visualization of reactor conditions, specifically investigating the flow fields in different scales, by simulation tools (CFD). The use of particle image velocimetry is shown to verify and optimize the CFD simulation itself on different scales.

The currently used methods to solve the issues of a process transfer are inadequate, time consuming and technically complex. For example, adjusting mixing parameters of a small scale to a large production reactor may result in appropriate mixing properties but on the other side may lead to poorer cell growth.

In the past, immediate transfer was attempted by taking conventional small scale cultivation data and either trying to replicate the small scale conditions in large scale or by trying to use models to predict the behavior in badly mixed systems by using data from small scale cultivation which are homogenously mixed. These attempts are highly likely to fail essentially due to the scale dependent flow-physical properties that are unavoidable. All of these approaches are of limited success until comprehensive and powerful cell models are available.

An alternative approach is to bring the cells into an environment that mimics the large scale production environment. Such approaches use a two vessel small scale system, where one reactor is mixed and supplied with nutrients, and the second reactor is not supplied with nutrients and can be either a mixed vessel, or a tubular reactor. As a complete system, this two-vessel systems have the appropriate mixing time of large scale vessels, but still fall short in adequately representing the conditions in large scale in terms of nutrient and oxygen distribution, and are technically very complex to implement. The further approach is the use of a two vessel in one vessel system, by dividing the culture volume with a divider plate into two parts. This accomplishes the same as a two-reactor system in terms of mixing times but still is unable to accurately mimic the large scale nutrient and oxygen distribution.

Therefore, there is the need for a method which allows an immediate transfer of process parameters from small lab scale to large production scale without causing any complications in the established bioprocess.

### SUMMARY OF INVENTION

It is the object of the present invention to provide a method which enables a smooth transfer of a bioprocess established in a model reactor to a corresponding production reactor. The object is solved by the subject matter of the present invention.

According to the invention, there is provided a method for generating a reactor geometry with specific defined fluid dynamics comprising:
a. The definition of the objective function;
b. The application of an algorithm for producing a number of at least 3 reactor geometries with randomized structures at the inner wall of the reactors;
c. The determination of fluid dynamic characteristics using automated computational fluid dynamics for the generated reactor geometries with randomized structures of step b);
d. The ranking of all generated reactor geometries according to the objective function of step a);
e. The selection of the best fitting randomized structures wherein the number of selected structures is less than the number of generated structures;
f. The application of an automated algorithm to randomly retract and add further randomized structures to these selected best fitting structures of step e) to generate an additional number of at least 3 reactor geometries with randomized structures;
g. The iterative repetition of steps c to f until a target criteria of similarity between objective function value and characteristic of randomly generated reactor geometries is found; and
h. optionally providing a digital file for 3D printing of the generated reactor.

According to one embodiment of the invention are the randomized structures derived from a library of structure elements. The structure elements are voxel based addition or plates.

A further embodiment relates to the method as described herein, wherein the outer diameter, height and minimal wall thickness of the target reactor is taken as input.

A further embodiment relates to the method as described herein, wherein the generation of fully enclosed spaces during random structure generation in step c and step e are avoided.

A further embodiment relates to the method as described herein, wherein the structure generation in spaces foreseen for assemblies inserted into the reactor after reactor manufacturing are avoided. The assemblies are for example sensors, stirrer, addition ports, or the like.

A further embodiment relates to the method as described herein, wherein the generated reactor geometry does not comprise overhangs according to the intended 3D printing direction.

A further embodiment relates to the method as described herein, wherein the generated reactor geometry comprise a minimum wall thickness.

A further embodiment relates to the method as described herein, wherein the generated reactor geometry comprise minimum open diameter of any structure.

A further embodiment relates to the method as described herein, wherein the objective function is a target value derived from an existing reactor.

A further embodiment relates to the method as described herein, wherein a single-vessel mixed reactor is generated based on the defined fluid dynamics derived from a large scale target reactor.

A further embodiment relates to the method as described herein, wherein the generated reactor is a small scale reactor.

A further embodiment relates to the method as described herein, wherein the computational methodology is selected from computational fluid dynamics, engineering equations, and deep learning Al derived CFD equivalents.

A further embodiment relates to the method as described herein, wherein the target value is one or more of kLa, mixing time, and nutrient distribution, or the like.

A further embodiment relates to the method as described herein, wherein the objective function is an optimum in any hydrodynamic characteristics of kLa, mixing time and nutrient distribution, or the like.

A further embodiment relates to the method as described herein, wherein for the second and any further iteration the objective function defined in step a and/or the method of adding elements in step b are adapted.

One embodiment of the invention relates to a reactor reflecting the same mixing properties as a target reactor different in size, wherein the reactor exhibits randomized structures at the inner wall.

The reactor may be a small reactor reflecting the same fluid flow profile as a target reactor. The reactor exhibits a specifically designed inner wall structure which allows to reflect for example the mixing properties of an existing target reactor which may be the same or different size.

A further embodiment relates to the method as described herein, wherein the reactor is produced by a method as described herein.

A further embodiment relates to the method as described herein, wherein said reactor is 3D printed.

One embodiment of the invention relates to the use of a reactor as described herein.

A further embodiment relates to the use of a reactor as described herein, wherein said reactor is used for scale-up or scale-down of a bioprocess.

A further embodiment relates to the use of a reactor as described herein, wherein the reactor is used for transferring a bioprocess to a large scale bioreactor.

A further embodiment relates to the use of a reactor as described herein, wherein the reactor is used for transferring a bioprocess from large scale to large scale.

One embodiment of the invention relates to method for scale-up of a bioprocess comprising of the following steps:
a. Determining of at least one objective function derived from large scale reactor characteristics
b. Generation of a small scale model reactor according to the method of any one of claims 1 to 17,
c. Manufacturing of the small scale model reactor by 3D printing;
d. Setting up said bioprocess in the small scale model reactor;
e. Determining the process parameters; and
f. Transferring the process parameters to the large scale reactor.

A further embodiment relates to the method as described herein, wherein the determined objective function is one or more selected from mixing time, mixing of nutrient feeds, shear rates, oxygen distribution, nutrient distribution, mass transfer, or the like.

As used herein, the term “objective function” refers to any function that formulates the objective. This objective function can have the optimization target of a minimum, maximum, a range or a specific value, and can be comprised of one or more constrains/equations that can be combined to one equation. The objective function can be as simple as a maximization/minimization goal of one parameter, for example the mixing time, or include any number of terms in any combination, like a minimum mixing time combined with a specific kLa.

The specific defined fluid dynamics may be determined by evaluation of the fluid dynamics of an existing reactor, or by defining optimized parameters. The fluid dynamics of an existing reactor may be determined by a Computational Fluid Dynamics (CFD) software.

According to one embodiment of the invention, the specific defined fluid dynamics of an existing large-scale reactor are determined and used or specified defined optimizing parameter are used. The specific defined optimized parameters are selected from either the group of process related parameters like mixing time, power input, etc. or are selected from the group of reactor related parameters like volume, surface area, and the like.

According to one embodiment of the invention the specific shape of the reactor structure is generated based on the results obtained from the CFD software in terms of mixing time or component distribution calculated with the CFD software. According to one example, the terms of mixing time or component distribution of dissolved oxygen and/or nutrients are calculated with the CFD software.

One embodiment of the invention relates to a model reactor reflecting the same mixing properties as an existing reactor, wherein the model reactor exhibits structures emulating the mixing properties of the existing reactor. The model reactor of comprises predetermined wall structures.

The model reactor may be a small-scale reactor or a medium-scale reactor, or even a large-scale reactor.

The model reactor may be produced by 3D-printing.

One embodiment of the invention relates to the use of a model reactor as described herein for scale-up or scale-down a bioprocess.

A method for scale-up a manufacturing process comprising the following steps:
a. determining the process conditions of a large-scale production reactor;
b. translation of the determined process condition of a) to a small-scale reactor;
c. evolute a model reactor structure based on translation of step b),
d. producing a 3D-model of the reactor exhibiting structures derived from step c),
e. establishing the manufacturing process in the model reactor of step d), and
f. transferring the established process to the large-scale production reactor.

The translation and evolution of the model reactor may be conducted by Computational Fluid Dynamics (CFD) software or the like.

According to one embodiment of the invention, the determined process condition is one or more selected from mixing time, mixing of nutrient feeds, shear rates, and mass transfer.

### BRIEF DESCRIPTION OF DRAWINGS

FIG. 1A: Stepwise process upscale from lab-scale to large scale as traditionally used.

FIG. 1B: The upscaling scheme of the pDS reactor technology according to the invention.

FIG. 2: Difference between traditional digital model based upscaling, and the presented generation of specialized physical small scale reactors and their use for upscaling of processes.

FIG. 3A: Detailed decision parameters and iterative approach to generate a new reactor design using random structure generation/subtraction and selection. At each generation (iteration) of the process, the reactors are expected to conform more and more to the desired target values (the objective function).

FIG. 3B: A selected generational map showing the interconnection of the different generation and their respective parent and daughter structures.

FIG. 4 depicts the mixing time of each generation starting with generation 1 and up to generation 5 for reaching a mixing time of at least 40 seconds to be representative of mixing in large scale.

FIG. 5 shows the addition if a tracer from the top in a small-scale bioreactor vessel (1 L) and the resulting tracer distribution after 8 seconds (5A) and after 21 seconds (5B).

FIG. 6 shows mixing curves for different reactor geometries offering different mixing times and different mixing behavior in comparison to exponential washout behavior.

FIG. 7 depicts a workflow starting from a large-scale target reactor followed by determining the fluid dynamic properties via CFD software to the final small lab model reactor exhibiting the same fluid dynamic properties as the large-scale target reactor.

FIG. 8 shows a scheme of a process transfer from large scale to large scale.

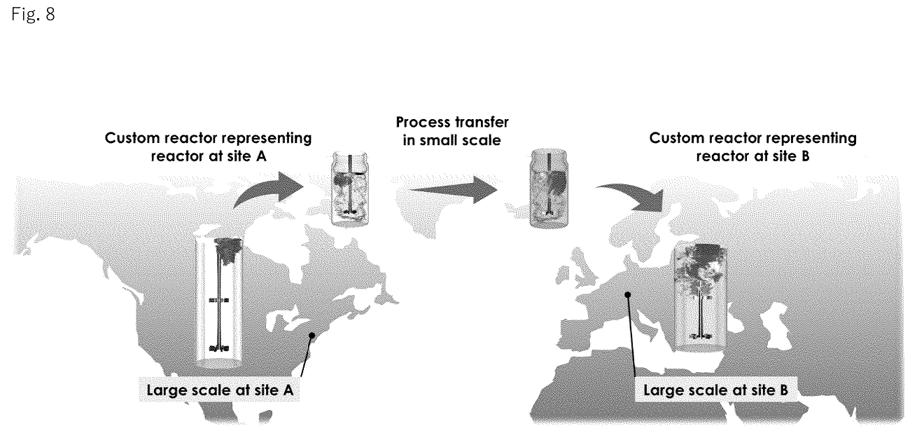

### DESCRIPTION OF EMBODIMENTS

The present invention provides a method for a smooth transfer of a bioprocess established in a reactor to a target reactor wherein the target reactor is different in size.

One embodiment of the invention relates to a method of designing a small scale reactor with specific mixing times, or as high mixing times as possible. One of the most important differences between small scale reactors and large scale reactors is the mixing time, with significantly higher mixing times in large scale reactors. This fundamental unavoidable hydrodynamic principle is one of the main causes why the same biological process if run in a small scale reactor differs in its performance in comparison to a large scale reactor and vice versa. For example, a process may be developed at small scale first, which exhibits already the performance of a large scale reactor by providing a small scale reactor having the same long mixing times as a large scale reactor.

One issue that is often overlooked is the bulk fluid flow of the system and how this changes across scale. Fluid displacement and velocity is not linear across scales, therefore the mixing profile of liquid movement will change not only based upon volume, tip speed, and diameter. It also depends upon the spatial distribution of power within the reactor and the formation or lack of small and large Eddy currents. In practical terms, designs should detune the localized mixing performance of the smaller volume system to match the bulk mixing and mass transfer performance of the large scale system. A good design will take into account the effects of baffling or flow disrupters.

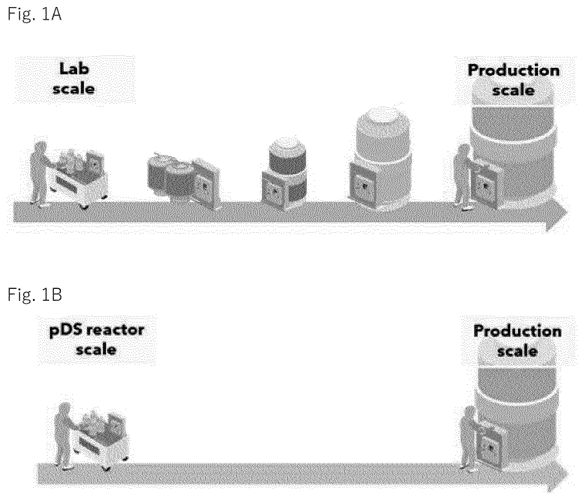

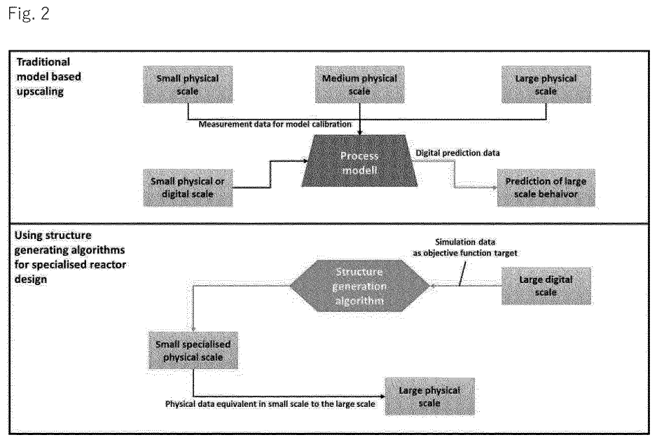

Typical process development for biotechnology includes first the determination of optimal parameters at small scale and then transferring that optimized process to large scale. As mixing times in larger reactors are significantly higher in comparison to small scale reactors, and changes in process performance are expected during upscaling, currently are processes scaled-up stepwise by increasing the reactor size (see FIG. 1A) in order to reduce cost and risk if process performance decreases in larger scales. This process is time consuming and costly and the optimum process parameters for large scale production cannot be achieved by this process, as process development already at production scale is cost-prohibitive. In order to reduce cost and risk pDS is used for up-scaling (see FIG. 1B).

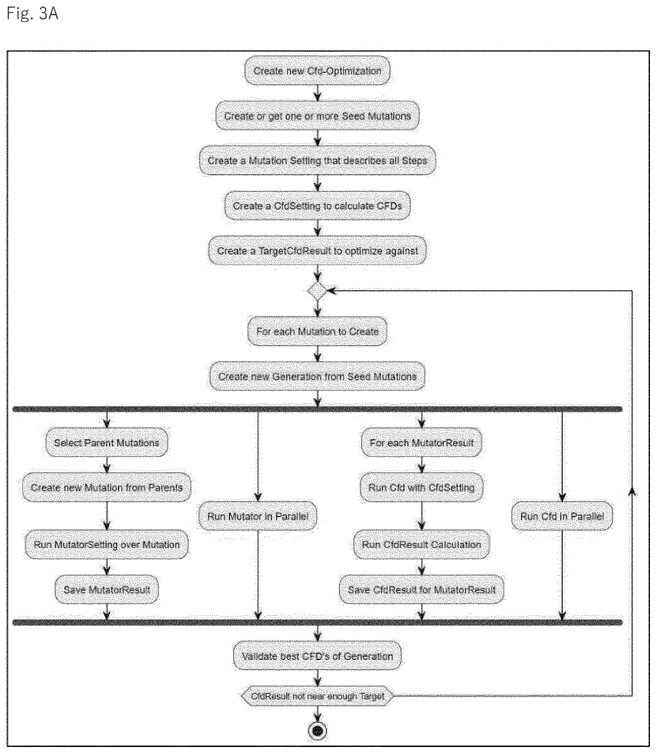

Besides cost and time savings, efficient optimization and up-scaling of biotechnological processes is critical for achieving several sustainable development goals. This is especially true considering the impact of microbial biotechnology in agrifood, environment, biopharmaceutical, and chemical industries. Many of these applications require scale-up after proof of concept. However, the behavior of such biologic culture systems remains unpredictable when shifting from a small lab-scale to industrial conditions. For that purpose, a full scale-up or scale-down computational framework is necessary. Although model-based up-scaling already exists as described herein these current available models are product and host specific. This means that for each process, data from the large-scale production needs to be produced to re-calibrate the model, making the usefulness in terms of time and cost savings very limited (FIG. 2). The present invention provides a direct up-scaling from a lab scale to the production scale. The inventive method is a host and product independent up-scaling or down-scaling method. The present invention also provides a model reactor with high mixing times.

Scale-up of fermentation processes in the biotech industry is a critical step in bringing bioprocess and bioproduct innovations to commercialization and life science will be the cornerstone of a future cyclic economy. This includes CO2 capture technologies, bioplastics, and novel foods as well as biopharmaceuticals like cancer treatments, vaccines, and gene therapy. As mentioned above, the upscaling step is notorious for performance losses and delays in development. The scale-down approach has been advocated as a smart way to minimize these issues, but current technologies are technically complex (2-vessel systems) or very limited by human design instead of automated design. The presented approach consists of interconnected activities to overcome the current shortages:
Detailed analysis of the conditions in a large-scale target reactor;
Computational representation of the dynamic fluid characteristic;
Translation of this dynamic fluid characteristic to a laboratory-scale model reactor using the presented automated structure generation of a small-scale bioreactor (see FIG. 2);
Production of said small-scale model reactor exhibiting complex inner geometry for example by 3D printing;
Developing a tailored process at laboratory-scale under conditions representative for the large-scale target reactor; and finally
Translation of the successful findings to the large-scale target reactor directly without any necessary intermediate steps (FIG. 1B).

The present invention provides a method for avoiding the time consuming, resource demanding and costly up-scaling in biotechnological manufacturing of a process as currently applied by first established in a small experimental reactor, then transferred in a number of sequential volume increasing steps to larger reactors until the final production volumes of up to several cubic meters is reached.

The target reactor may be a large-scale production reactor for use in a plant for the production of various desired biotechnological products. The large-scale production reactor may have a volume of about 100 L, 500 L, 1,000 L or of up to several cubic meters.

The model reactor may be a small-scale lab reactor. The small-scale model reactor may have a volume of 0.1 L, 0.5 L, 1.0 L 1.5 L, 2.0 L, 5.0, or up to 10.0 L.

Specifically the flow-physical properties differ significantly in reactors of different volume and shape. For example, the distribution of nutrients and the mixing time are mainly depending on the volume and shape of the reactor used. Every time when an existing and well-established process is transferred to a reactor of different size plenty of time and resources are required to redevelop the process in the target reactor with the goal of achieving the same results, which cannot always be met.

One embodiment targets a mixing time representative for a large scale reactor. For example, a reactor of 20 m³ typically has mixing times of about 40-50 seconds.

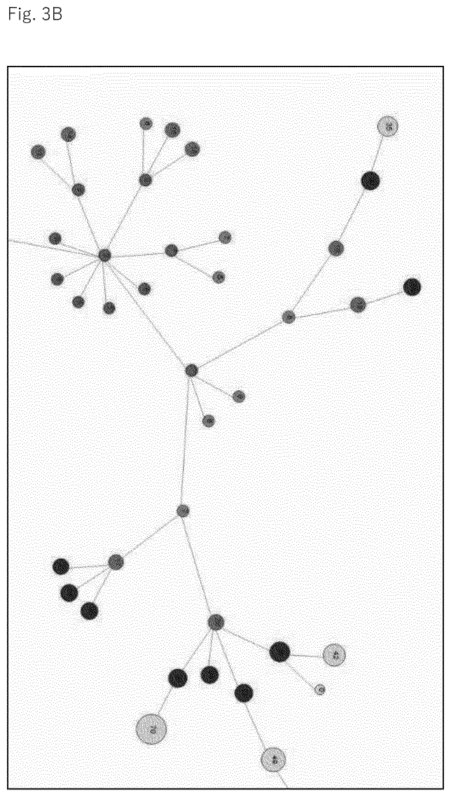

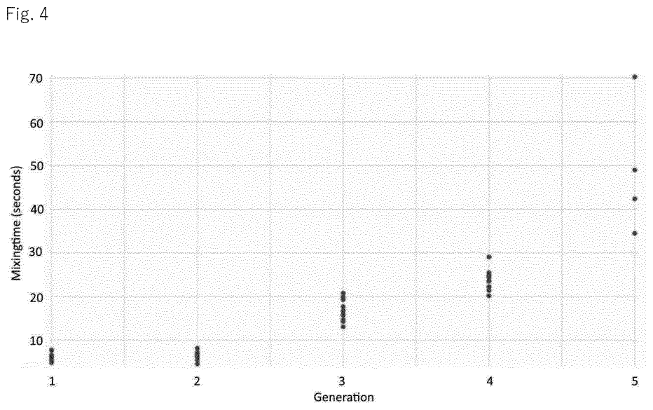

This mixing time of about 40-50 seconds should be reflected by the generated small scale model reactor. The general decision scheme for random structure generation to yield said specific hydrodynamic behavior in a small scale model reactor is shown in FIG. 3. The loop of structure generation and detraction is performed as long as required to yield the specific target goal. In this case, the algorithm will automatically generate new reactor geometries based on the last iteration, and automatically evaluate them by CFD (determining their mixing time) until a reactor structure is generated that exhibits the desired mixing time of about 40 seconds.

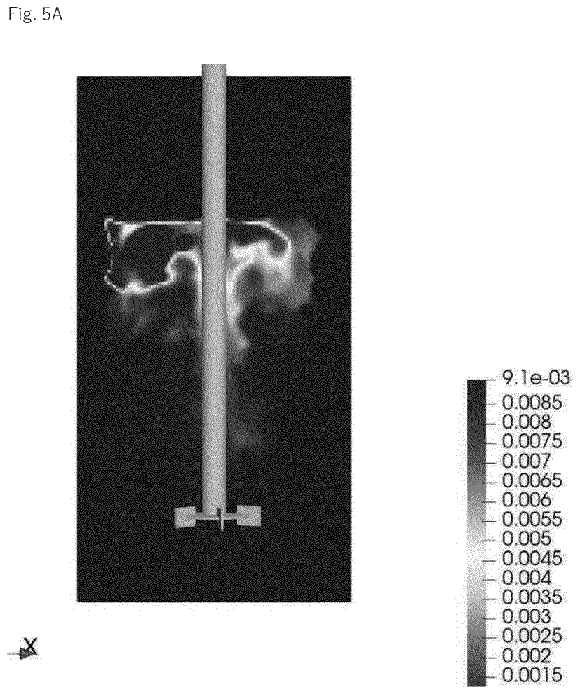

Using this methodology, the mixing time necessarily will increase with each generation, if suitable parameters for the amount and kind of structure generated and deleted in each iteration are selected. According to an exemplary embodiment of the invention, a 1 L bioreactor was designed using the described methodology, with the target goal of at least 40 seconds mixing time. Bioreactors of 1 L size usually have mixing times of only 2-5 seconds, which is by way too fast to be representative for the mixing time of more than 40 seconds of the large scale reactors. FIG. 4 shows the mixing times of each generation of randomly generated reactors using the described methodology and shows the successful increase of mixing time with each iteration.

These progressively longer mixing times are achieved by the random structure addition and subtraction from the 3D structure of the bioreactor, and with each generation, the best performing structures according to the objective function are taken as the base for the next generation of structure addition/subtraction.

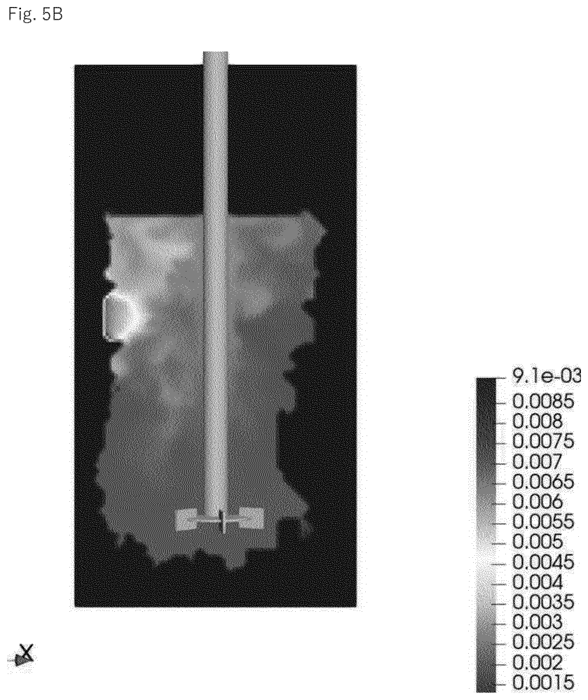

The mixing time increase depends on the addition of structures to the inner wall hindering the mixing of any added substance e.g., nutrients as they break the efficient mixing of small scale reactors. The nature and design of structures for the inner wall in this embodiment is selected to be purely random and the mixing behavior can be easily visualized by the addition of a scalar into the CFD simulation from the top of the reactor, simulating the addition of nutrients by a feeding line at the top of the reactor. In FIG. 5A, B is the distribution of such tracer in one of the reactor structures generated in this embodiment shown that exhibited more than 40 seconds mixing time. This behavior is not possible in conventional bioreactors, as the ingredients in the reactor would be homogenously mixed after 2-5 seconds in such small scale reactors. Only the iterative random structure approach allows this kind of tracer distribution representative of large scale reactors.

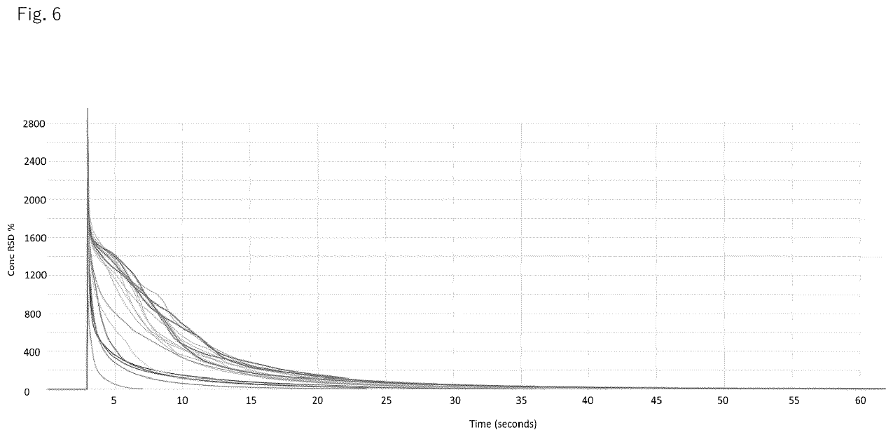

The difference between a conventional single plate separating one vessel or the two-vessel system can also be visualized by the resulting standard deviation of tracer in the bioreactor over time. For a two-vessel system as well as for a bioreactor separated in two parts by a plate with holes, the resulting curve will always resemble an exponential washout curve. This exponential washout curve is not what is seen in a large bioreactor, as the large bioreactor is comprised of different zones being differently mixed with the main bulk of the liquid in the bioreactor, resulting in a more complex nutrient mixing over time. (FIG. 6). The mixing curves represented by the standard deviation of tracer over time shown offer behavior from quasi-exponential washout behavior (lower curves) to a more complex mixing behavior that is potentially more suitable as scale-down bioreactor for process development and more representative of how mixing curves look like in large scale bioreactors. The presented methodology can either use the mixing time as an objective function, or it can use the resulting mixing curve as presented in FIG. 6 as objective function to produce a physical small scale reactor that more accurately represents the conditions in large scale bioreactors.

In one embodiment of the invention, the reactor was computationally evaluated using M-Star CFD, but this evaluation can of course be done with any other CFD modelling software such as for example, Siemens StarCCM+or opensource solutions like OpenFoam. The basic idea of CFD is to solve the equations of motion of the fluid in the reactor (i.e., the Navier-Stokes equations). These equations describe conservation of mass and the balance of momentum in the fluid. In particular, the momentum balance is of a nonlinear nature, which prohibits analytical solutions for virtually all practical flows. This requires discretizing the mathematical equations and solving them numerically. When scaling up, the flow becomes more turbulent and a feature of turbulent flows is a wide span of scales both in space and in time leading to significant mixing differences in small and large-scale reactors.

Histograms of well/badly mixed areas as well as all other values or series that are calculated by the CFD can be used as objective function in the presented embodiment for determining if large and small-scale reactors exhibit the same flow characteristics. According to the invention any target-property may be used if a rating target property can be calculated by a suitable software, e.g., by CFD. Even combinations of properties with rated properties could be used, such as a mixing time >40 seconds and simultaneously targeting a certain kLa gas transfer coefficient.

The reactor shapes both in small and large scale may be chosen arbitrarily as long as it can be modelled in 3D. The shape may be a simple cylindrical reactor with a known volume and a stirrer which optionally includes feeding pipes, other layouts, sizes or structures needed to use the reactor.

For one embodiment according to the invention a simple cylindrical reactor with a volume of 1 L was used as model reactor but any other reactor geometry is possible.

The reactors provided by the invention are physical downscale models of large scale hydrodynamic behavior, and therefore are suitable to be host and product independent. The problem of a missing suitably detailed model for cell behavior that is the road block for digital model predictive power for the traditional approach (FIG. 2, upper panel) is not applicable to this invention, as no modelling of cells is done. The cells used are transferred into a physical environment representative of large scale production reactors, allowing the direct upscaling of process parameters developed in small scale, to large scale production without the loss of performance (FIG. 1 right side).

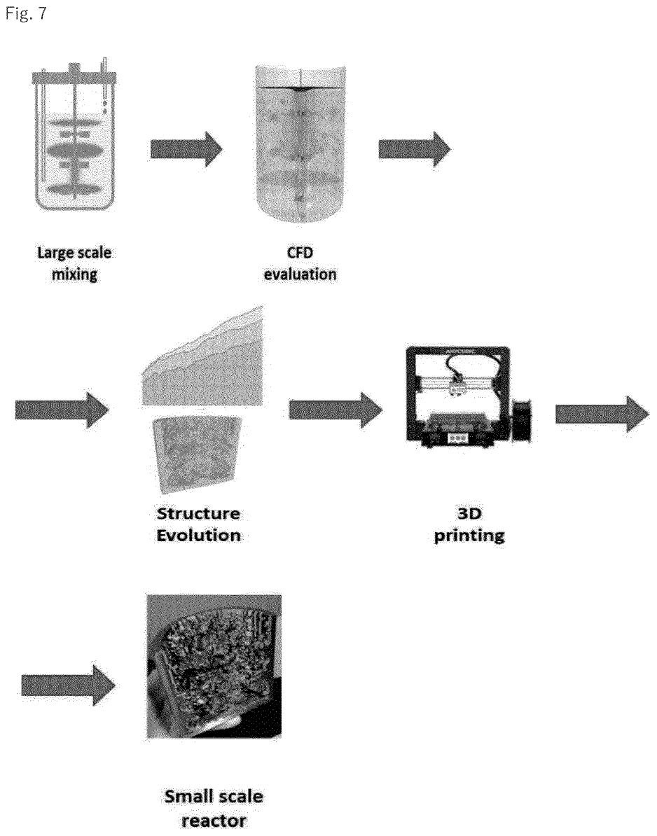

Finally, after the digital generation of the geometry of the small scale reactor being representative for the mixing behavior of a large scale reactor, the small model reactor can be 3D printed, as the digital file for 3D printing is already provided by the method according to the invention. 3D printing is also the only manufacturing technology that will be capable of accurate and fast manufacture of the complex geometries resulting from the described methodology. The production of the model reactor can be easily achieved by 3D printing. Since the algorithm may ensure a reactor ready for 3D printing, the physical downscale reactor can be realized by any 3D printing technology. Suitable 3D printing processes are for example laser sintering, FDM, DLP, LCA or any other methodology. Suitable 3D printing materials are for example thermoplastics such as PLA or ABS but also resins, medical resins, glass and ceramic resins and any sintering material from plastics to metals without any restrictions. The interconnection of the methodology of generating the geometry of the reactor followed by the manufacturing of the reactor is depicted in FIG. 7.

The mixing properties are evaluated for the large scale, and the small scale is iteratively developed to achieve the same flow properties by randomly changing its structure and selecting the best performers for the next iteration.

Different approaches for choosing the model reactors for each generation can be used (e.g. use the best x ratings, additionally use some outliers). Additionally various mutation approaches can be used, potentially only for specific generations (e.g. use larger changes in the reactor structure in the first iteration and smaller scale changes in subsequent iterations).

The process to get from a model reactor to a large-scale production reactor with the same previously identified objective functions used is an evolutionary approach (random change and selection of best performers).

The optimization Loop mainly contains the following steps:
1. Choose a suitable model reactor for the loop;
   If it is the first loop, the provided model reactor is used;
   If not, the reactor with the best rating is chosen (or multiple best performing reactors);
2. The model reactor is interbred with other well performing specimen of the last generation or mutated randomly in order to create a number of reactor variations (about 100 specimen, this number can be freely selected);
3. All mutated reactors are run through the CFD software;
4. A rating based on the CFD results is calculated taking into account the key parameters of the large-scale production reactor; and
5. This loop is as often repeated as required to reach the calculated CFD results to be near enough the previously defined key parameters. This may take up to 50 loops (this number can vary depending on the individual simulation).

A model mutated reactor is generated based on the following steps:
a. Creation of a random structure until a target volume is reached;
b. Removal of the random structure until a target volume is reached;
c. Creation of weighted random structure with seed-points to achieve bigger structures and more change per each generation as a result;
d. Creation of a structure from predefined elements (e.g., discs sitting on the walls, bawls, . . . );
e. Mutation of size and position of the structures of the predefined elements;
f. Usage of predefined elements as origin for random structures.

A model reactor may be generated by using mixed approaches, e.g., by creating predefined structures followed by a weighted random structure approach to finally mutate the predefined structures accordingly.

Finally respective algorithms are used for generating a 3D printable file of the model reactor. The quality of the model reactor is checked for having a valid structure, e.g., no holes in the model reactor wall and a printable structure that does not need any supports.

The optimization loop is finished when the CFD key parameters are near enough to the predefined parameters of the large-scale production reactor.

Another embodiment of the invention using the small scale representative reactors as described herein for a process transfer of a large scale process running in one facility to another facility, wherein the process in both facilities is using large scales reactors.

1. A method for generating a reactor geometry with specific defined fluid dynamics comprising:
a. defining an objective function;
b. applying an algorithm for producing at least 3 reactor geometries with randomized structures at inner walls of reactors, thereby producing generated reactor geometries;
c. determining fluid dynamic characteristics using automated computational fluid dynamics for the generated reactor geometries with randomized structures of step b);
d. ranking all of the generated reactor geometries according to the objective function of step a);
e. selecting the best fitting randomized structures wherein the number of selected structures is less than the number of generated structures;
f. applying an automated algorithm to randomly retract and add further randomized structures to these selected best fitting structures of step e) to generate an additional number of at least 3 reactor geometries with randomized structures;
g. iteratively repeating steps c) to f) until a target criteria of similarity between objective function value and a characteristic of randomly generated reactor geometries is found; and
h. optionally providing a digital file for 3D printing of the reactor.

2. The method according to claim 1, wherein the randomized structures are derived from a library of structure elements.

3. The method according to claim 2, wherein the structure elements are voxel based addition or plates.

4. The method according to claim 1, wherein the outer diameter, height and minimal wall thickness of the reactor is taken as input.

5. The method according to claim 1, wherein the generation of fully enclosed spaces during random structure generation in step c) and step e) is not performed.

6. The method according to claim 1, wherein structure generation in spaces foreseen for assemblies inserted into the reactor after reactor manufacturing is not performed.

7. The method according to claim 6, wherein the assemblies are sensors, stirrer, or addition ports.

8. The method according to claim 1, wherein the reactor geometry does not comprise overhangs according to the intended 3D printing direction.

9. The method according to claim 1, wherein the reactor geometry comprises a minimum wall thickness.

10. The method according to claim 1, wherein the reactor geometry comprises a minimum open diameter of any structure.

11. The method according to claim 1, wherein the objective function is a target value derived from an existing reactor.

12. The method according to claim 1, wherein a single-vessel mixed reactor is generated based on the defined fluid dynamics derived from a large scale target reactor.

13. The method according to claim 1, wherein the reactor is a small scale reactor.

14. The method according to claim 1, wherein the computational methodology is selected from computational fluid dynamics, engineering equations, and deep learning AI derived CFD equivalents.

15. The method according to claim 11, wherein the target value is one or more of kLa, mixing time, and nutrient distribution.

16. The method according to claim 1 wherein the objective function is an optimum in any hydrodynamic characteristics of kLa, mixing time, or nutrient distribution.

17. The method according to claim 1, wherein for the a second and any further iteration the objective function defined in step a) and/or the method of adding elements in step b) are adapted.

18. A reactor reflecting the same mixing properties as a target reactor different in size, wherein the reactor exhibits randomized structures at an inner wall.

19. (canceled)

20. The reactor according to claim 18, wherein said reactor is 3D printed.

21-23. (canceled)

24. A method for scale-up of a bioprocess comprising of the following steps:
a. determining at least one objective function derived from large scale reactor characteristics;
b. generating a small scale model reactor according to the method of claims 1;
c. manufacturing of the small scale model reactor by 3D printing;
d. setting up said bioprocess in the small scale model reactor;
e. determining the process parameters; and
f. transferring the process parameters to the large scale reactor.

25. The method of claim 24, wherein the determined objective function is one or more function selected from the group consisting of mixing time, mixing of nutrient feeds, shear rates, oxygen distribution, nutrient distribution, and mass transfer.
